(19) United States
(12) Patent Application Publication
(10) Pub. No.: US 2014/0055600 A1
(43) Pub. Date: Feb. 27, 2014

(54) IN-LINE PARTICLE DISCRIMINATION FOR COSMETIC INSPECTION

(71) Applicants: Brett C. ONG, San Jose, CA (US); Daniel O. Karraker, Cupertino, CA (US); Joseph C. Rubin, San Jose, CA (US)

(72) Inventors: Brett C. ONG, San Jose, CA (US); Daniel O. Karraker, Cupertino, CA (US); Joseph C. Rubin, San Jose, CA (US)

(73) Assignee: Apple Inc., Cupertino, CA (US)

(21) Appl. No.: 13/594,740

(22) Filed: Aug. 24, 2012

(51) Int. Cl. G06K 9/46; H04N 7/18

(52) U.S. Cl. 348/92; 382/108; 348/E07.085

(57) ABSTRACT

A method for in-line cosmetic inspection of at least a portion of a surface of a product includes identifying if at least one blemish exists on the portion of the surface, disturbing the portion of the surface based on the identifying, and determining if the at least one blemish is immobile based on the disturbing.

### FIELD OF THE DESCRIBED EMBODIMENTS

The described embodiments relate generally to device manufacturing, and more particularly, to in-line particle discrimination and blemish identification for cosmetic inspection during device manufacturing.

### BACKGROUND

Conventionally, automated cosmetic inspection of devices is limited to a positive or negative result of a device's overall quality compared to a threshold value or set of threshold values. For example, automated cosmetic inspection may compare a measurement of a manufactured device's attributes to determine if minimum threshold color translucency, chromaticity, surface evenness, dimensions, or other suitable thresholds are met satisfactorily. Products failing this determination are typically discarded.

This automated cosmetic inspection may be supplemented through a random sampling or statistical analysis involving objective or subjective inspections by a technician. The objective or subjective inspections may include device manipulation, handling, inspection, and provide a final quality score for the sample to be used in an overall analysis of production quality. However, it is important to note that while objective or subjective analysis of individual samples may result in a more thorough screening of possibly defective products, the inspections themselves may introduce surface blemishes, scratches, or other unintentional damage which may render the sampled products unsellable without further processing.

Therefore, what is needed is a method of in-line automated cosmetic inspection which better analyzes product quality while limiting the need for costly individual inspections which may introduce surface blemishes or other damage to products.

### SUMMARY OF THE DESCRIBED EMBODIMENTS

This paper describes various embodiments that relate to device manufacturing and associated cosmetic inspection processes.

According to one embodiment of the invention, a method for in-line cosmetic inspection of at least a portion of a surface of a product includes identifying if at least one blemish exists on the portion of the surface, disturbing the portion of the surface based on the identifying, and determining if the at least one blemish is immobile based on the disturbing.

According to an additional embodiment of the invention, a method for in-line cosmetic inspection of a product includes identifying blemishes on a surface of the product, disturbing the surface of the product based on the identifying, and determining if the identified blemishes are immobile based on the disturbing.

According to an additional embodiment of the invention, a system for cosmetic inspection for products from a manufacturing line includes a cosmetic inspection station configured to receive a product from the manufacturing line, a surface disturbance generator configured to disturb a surface of a product received at the cosmetic inspection station, an image capture device configured to capture images of the surface of the product received at the cosmetic inspection station, and a controller configured to identify immobile blemishes on the surface of products received at the cosmetic inspection station based on operation of the surface disturbance generator and the image capture device.

Other aspects and advantages of the invention will become apparent from the following detailed description taken in conjunction with the accompanying drawings which illustrate, by way of example, the principles of the described embodiments.

### BRIEF DESCRIPTION OF THE DRAWINGS

Various aspects of this disclosure may be better understood upon reading the following detailed description and upon reference to the drawings in which:

FIG. 1 is a schematic of a system for in-line cosmetic inspection, according to an embodiment of the present invention.

FIG. 2 is an expanded view of a portion of a cosmetic inspection station of the system of FIG. 1.

FIGS. 3A-3B illustrate a portion of an in-line cosmetic inspection methodology, according to an embodiment of the present invention.

FIG. 4 is a flowchart of a method of in-line cosmetic inspection, according to an embodiment of the present invention.

FIG. 5 is a flowchart of a method of identifying surface blemishes, according to an embodiment of the present invention.

FIG. 6 is a flowchart of a method of identifying immobile blemishes, according to an embodiment of the present invention.

FIG. 7 is a flowchart of a method of in-line cosmetic inspection, according to an embodiment of the present invention.

### DETAILED DESCRIPTION OF SELECTED EMBODIMENTS

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

As described herein, systems and methods for in-line cosmetic inspection are provided which better analyze product quality while limiting the need for individual inspections which may introduce surface blemishes or other damage to products. The in-line systems and methods may be integrated with existing manufacturing lines such that costs of implementation are reduced as compared to conventional technology.

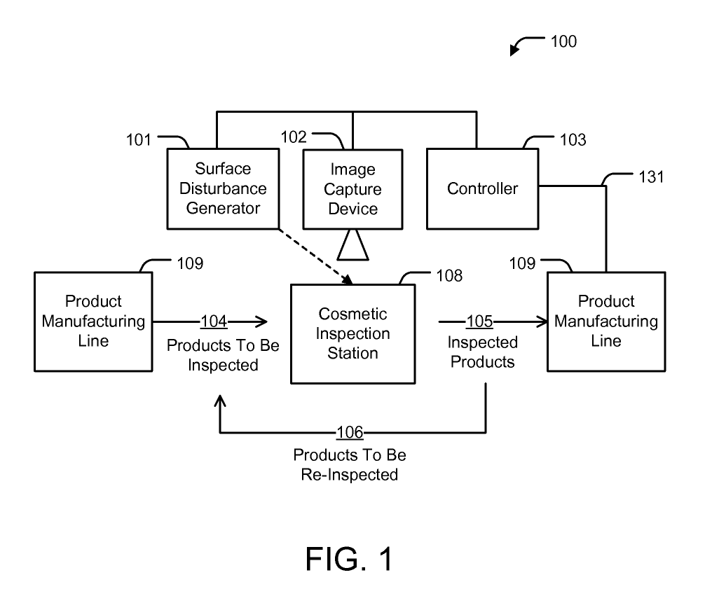

Turning to FIG. 1, a schematic of a system 100 for in-line cosmetic inspection is illustrated, according to an embodiment of the present invention. The system 100 may be a portion of a larger manufacturing system, for example, a system configured to manufacture personal electronic devices or other products. The system 100 may be integrated with product manufacturing line 109 such that cosmetic inspection facilitated through system 100 is an “in-line” inspection process. The product manufacturing line 109 may provide a plurality of products to be inspected via conveyance 104. The products to be inspected may be fully or partially assembled products or portions thereof, for example, screens, housings, backings, panels, or other suitable portions of a product which may benefit from cosmetic inspection.

The products to be inspected may be fed via conveyance 104 onto cosmetic inspection station 108. The cosmetic inspection station 108 may receive and inspect the products with an integrally arranged surface disturbance generator 101, image capture device 102, and controller 103.

The cosmetic inspection station 108 may include a portion of the conveyance 104, or may include a separate conveyance configured to hold, support, and inspect a product received.

The surface disturbance generator 101 may include one or more mechanisms for disturbing a surface of a received product. The mechanisms may include any suitable form of surface disturbance generators, including compressed air nozzles, valves, compressors, compressed air lines, gas actuators, fans, blowers, or other suitable mechanisms. The surface disturbance generator 101 may be arranged to direct air flow over a surface of a received product such that any loose or relatively loose debris is disturbed while not actually damaging a product's surface. The surface disturbance generator 101 may also be arranged to direct a fluid flow over the surface of a received product, wherein the directed fluid is one of compressed air and uncompressed air. The surface disturbance generator 101 may also include a mechanical surface disturbing mechanism, for example, a vibrating mechanism configured to vibrate a product such that any loose or relatively loose debris is disturbed. The vibrating mechanism may include a counter-weighted motor shaft, solenoid, or other suitable mechanism.

The image capture device 102 may include a plurality of components configured to receive and record an image of a portion of a surface of a received product. The plurality of components may include at least one lens and an image sensor. The at least one lens may include a magnifying lens configured to magnify a surface of a received product and direct incoming light to the image sensor. The image sensor may be any suitable image sensor, including a charge-coupled device based image sensor or a complementary metal-oxide-semiconductor based image sensor. The image sensor is configured to capture at least one image of a surface of a received product and direct the same to controller 103 for image processing.

Although illustrated as separate components, it should be understood that the controller 103 may be integrally arranged with the image capture device, or alternatively, an image sensor controller may be arranged within the image capture device 102 (not illustrated) and disposed to communicate image information with controller 103. Furthermore, the controller 103 is configured to identify immobile blemishes on the surface of products received at the cosmetic inspection station 108 based on operation of the surface disturbance generator 101 and the image capture device 102. For example, the controller may be configured to execute any method of in-line cosmetic inspection as described herein, and controllably direct the surface disturbance generator 101 and image capture device 102 to perform any associated steps or portions of the method described herein.

Additionally, the controller 103 may be in communication with the product manufacturing line 109 via communication channel 131 such that inspected products may controllably flow onto the cosmetic inspection station 108 and be released onto conveyance 105 for further processing on the product manufacturing line 109. Alternatively, or in combination, products may be re-inspected by insertion onto cosmetic inspection station 108 via conveyance 106. Conveyance 106 may include physical removal of a product by a user or technician and physical insertion onto cosmetic inspection station 108.

Thus, as illustrated in FIG. 1, an in-line cosmetic inspection station may receive and inspect products from product manufacturing line 109, and reinsert the same after processing. Hereinafter, cosmetic inspection stations and methodologies to control the same are described in detail.

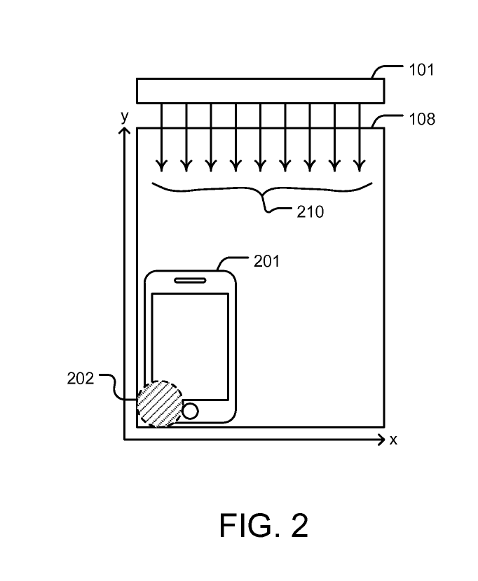

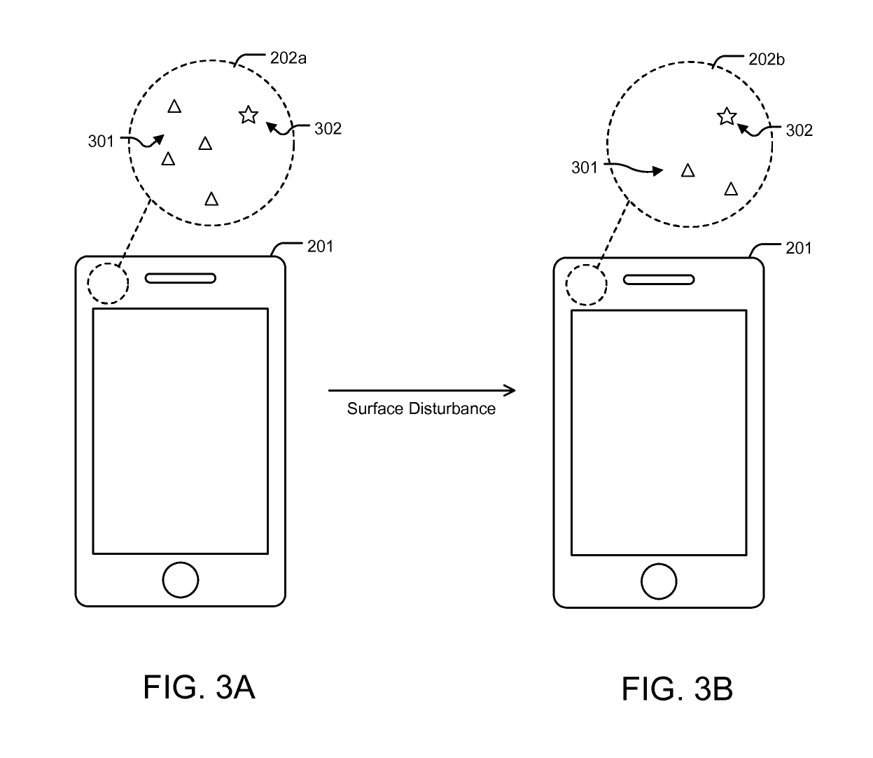

FIG. 2 is an expanded view of a portion of a cosmetic inspection station 108 of the system of FIG. 1. As shown, a product 201 may be received at cosmetic inspection station 108. A view or area to be viewed 202 represents a portion of the product 201 that may be imaged or photographed by image capture device 102. During cosmetic inspection, one or more surface disturbing mechanisms 210 may be actuated to disturb or move loose or relatively loose particles or debris on a portion of the surface being imaged. After surface disturbance, one or more images may be taken and compared to prior images to determine if any detectable blemishes are surface defects or loose particles. This is illustrated more clearly in FIGS. 3A-3B and described below.

FIGS. 3A-3B illustrate a portion of an in-line cosmetic inspection methodology, according to an embodiment of the present invention. As shown, first image 202a depicts a plurality of detectable surface blemishes 301-302 on a surface of product 201. Upon detection, the surface of the product 201 may be disturbed, for example, by applying compressed air, uncompressed air, or vibrating the product 201. Thereafter, a second image 202b may be taken and processed, and further compared to image 202a to determine that blemishes 301 are loose particles while blemish 302 may be an immobile particle or surface defect. Thereafter, manual inspection may be appropriate to ascertain whether blemish 302 is in fact loose debris or a surface defect which may or may not be repairable. Alternatively, the product 201 may be tagged for further inspection and reinserted onto a product manufacturing line.

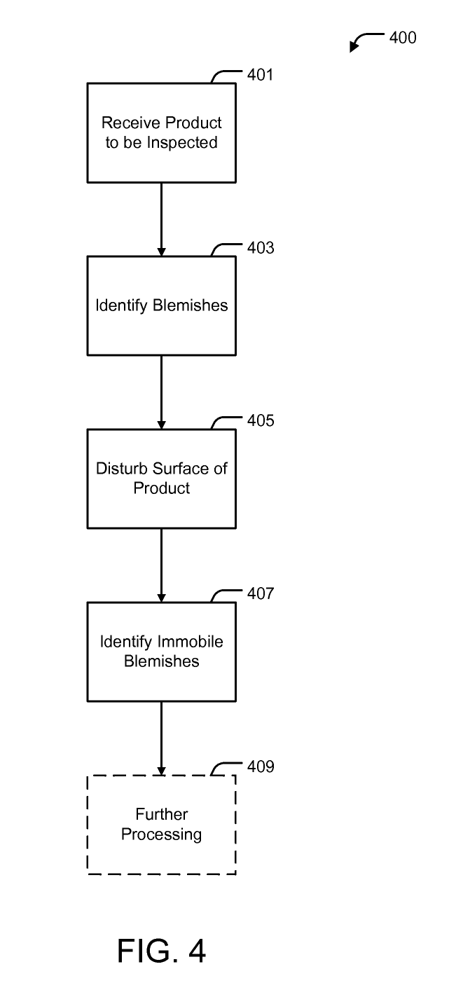

Hereinafter, additional aspects of methods of in-line cosmetic inspection are described in detail with reference to FIGS. 4-7.

FIG. 4 is a flowchart of a method 400 of in-line cosmetic inspection, according to an embodiment of the present invention. The method 400 includes receiving a product to be inspected at block 401. The receiving may be facilitated through a conveyance or conveyor system, and may include the transfer of the product onto or into a cosmetic inspection station.

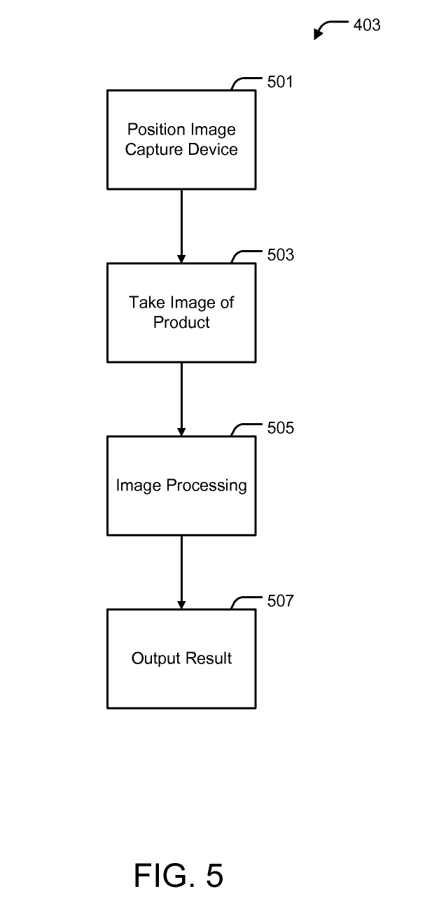

The method 400 further includes identifying blemishes on a portion of a surface of a received product at block 402. The identifying may include imaging the portion of the surface with an image capture device to create an image and processing the image to determine if blemishes may exist on the portion of the surface as described below with reference to FIG. 5.

Turning now to FIG. 5, a flowchart of a method 403 of identifying surface blemishes is illustrated, according to an embodiment of the present invention. As shown, the method 403 may include positioning an image capture device over a portion of the received product to be imaged at block 501. The positioning may include focusing any associated imaging lenses, laterally and/or longitudinally moving the image capture device and/or lenses to an area to be imaged, altering a tilt or angle of the image capture device, or other suitable positioning maneuvers. The method 403 further includes taking an image of the portion of the surface of the product at block 503, for example, by cycling a shutter sequence and exposing an image sensor to light reflected off the surface of the product. Light may be ambient light, or may include artificially produced and/or filtered light, such as from a flash or back light. Thereafter, the method 403 includes image processing to identify any potential blemishes at block 505. The image processing may include masking all or a portion of the image using a known mask depicting surface features which may be inadvertently interpreted as blemishes. The known mask may be based on an ideal product and may be embodied as a bit mask or other data structure by which to pre-process the image used to initially identify blemishes. Upon finishing processing, the method 403 includes returning or outputting results of the processing at block 507.

Turning back to FIG. 4, the method 400 further includes disturbing at least a portion of the surface of the product at block 405 if blemishes have been potentially identified. For example, if block 403 identifies at least one blemish, a surface disturbance generator may be initiated to attempt to dislodge or move loose particles. The surface disturbance generator may be localized at the portion of the surface being inspected, or may be applied to more or less of the surface of the product, for example by controllably releasing a fluid flow over a portion of the surface (e.g., releasing a flow of air or compressed air), vibrating the surface, or otherwise disturbing the surface.

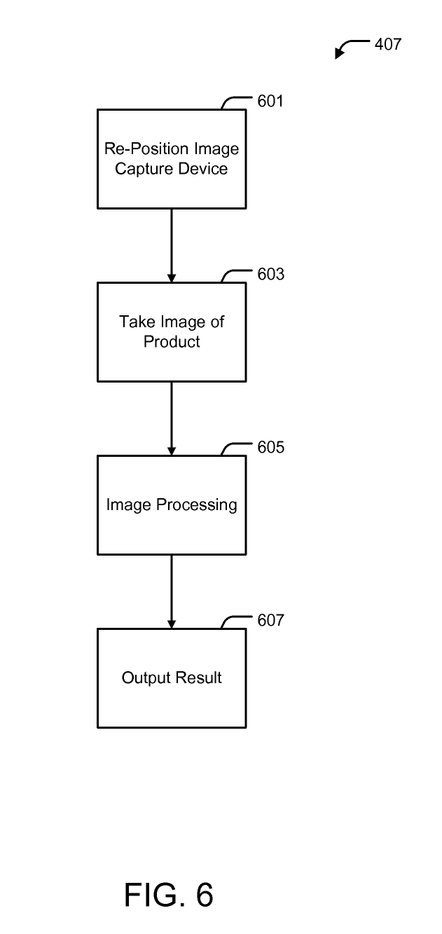

The method 400 further includes identifying immobile blemishes at block 407. For example, as illustrated in FIG. 3B, blemish 302 may be an immobile blemish which may comprise a surface defect or immobile particle, such as a smudge or other particle not easily dislodged. Therefore, such a blemish may be determined to be immobile at block 407, which is described in more detail below with reference to FIG. 6.

FIG. 6 is a flowchart of a method of identifying immobile blemishes, according to an embodiment of the present invention. As shown, the method 407 may include re-positioning an image capture device if necessary over the portion of the received product previously imaged at block 601. The re-positioning may include focusing any associated imaging lenses, laterally and/or longitudinally moving the image capture device and/or lenses to an area to be imaged, altering a tilt or angle of the image capture device, or other suitable positioning maneuvers. Block 601 may be optional if the image capture device has no need to be re-positioned. The method 407 further includes taking an image of the portion of the surface of the product at block 603, for example, by cycling a shutter sequence and exposing an image sensor to light reflected off the surface of the product. Light may be ambient light, or may include artificially produced and/or filtered light, such as from a flash or back light. Thereafter, the method 407 includes image processing to identify any potential immobile blemishes/particles at block 605. The image processing may include masking all or a portion of the image using a known mask depicting surface features which may be inadvertently interpreted as blemishes and/or comparing the image created at block 603 to an image created at block 503 to determine if previously identified blemishes have been disturbed or moved. The known mask may be based on an ideal product and may be embodied as a bit mask or other data structure by which to pre-process the image used to initially identify blemishes. The comparison between images created at blocks 503 and 603 may include any suitable comparison, including post-processing, flattening, feature identification, feature location identification, and comparisons therebetweeen to determine if blemishes have moved. Upon finishing processing, the method 407 includes returning or outputting results of the processing at block 607.

Turning back to FIG. 4, the method 400 also includes further processing of the product at block 409 based on the identification of immobile blemishes. For example, if no immobile blemishes are identified, the product may be reinserted at a product manufacturing line for assembly, manipulation, and/or further inspection. If one or more immobile blemishes have been identified, the product may be removed or tagged for further inspection later in manufacturing, further imaged or subjected to other automated inspection processes, or subjected to human-inspection, for example, visual inspections including surface cleaning to determine if the identified immobile blemish is repairable, removable, or simply a misidentification.

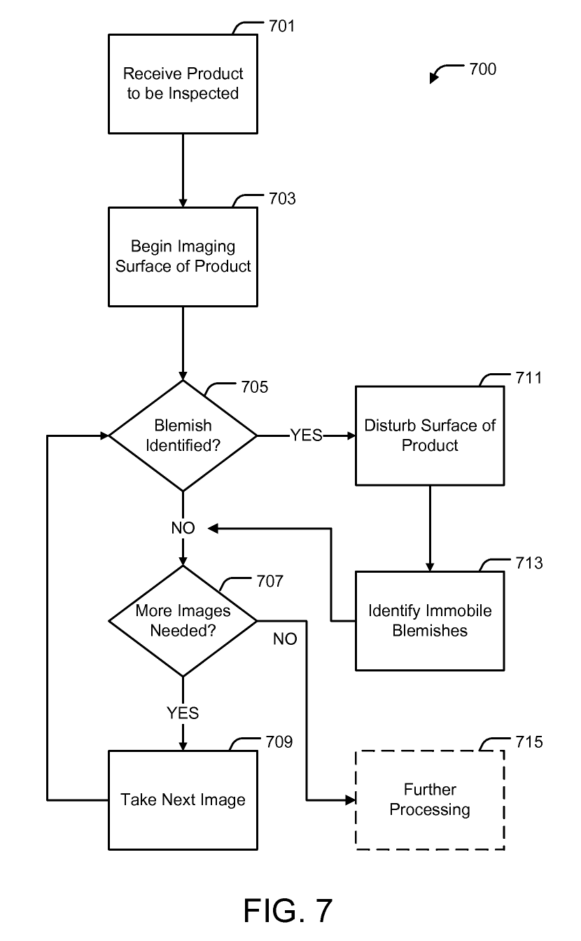

Although described above as particularly related to inspection of one or more images taken of a particular portion of a surface area of a product, it should be understood that iterative imaging and surface disturbance are also applicable to embodiments, and the particular order or number of images taken may be altered without departing from the spirit and scope of embodiments as described herein. Furthermore, iterative inspection of several different areas of a product may be integrated into cosmetic inspection processes, as described more fully below with reference to FIG. 7 below.

FIG. 7 is a flowchart of a method 700 of in-line cosmetic inspection, according to an embodiment of the present invention. The method 700 includes receiving a product to be inspected at block 701. The receiving may be facilitated through a conveyance or conveyor system, and may include the transfer of the product onto or into a cosmetic inspection station.

The method 700 further includes beginning imaging of a surface of a product at block 703. Beginning imaging may include preparing an image capture device to image a portion of the surface, and taking at least one image of the portion of the surface. The preparing may include focusing any associated imaging lenses, laterally and/or longitudinally moving the image capture device and/or lenses to an area to be imaged, altering a tilt or angle of the image capture device, or other suitable preparation maneuvers. Taking the at least one image may include cycling a shutter sequence and exposing an image sensor to light reflected off the surface of the product. Light may be ambient light, or may include artificially produced and/or filtered light, such as from a flash or back light.

Thereafter, the method 700 includes determining if at least one blemish is identifiable on the at least one image at block 705. Blemish identification may be similar to the methods described above, and may include image processing, masking, or any other suitable processing.

If no blemishes have been identified, the method 700 may iteratively image more of the surface of the product through blocks 707 and 709 until a satisfactory, predetermined, or desired number of images of portions of the surface of the product have been processed. If the predetermined or desired number of images have been processed, or if no more images are necessary during the cosmetic inspection process, the method 700 may include further processing at block 715.

If at least one blemish has been identified through block 705, the method 700 may include surface disturbance at block 711 and immobile blemish identification at block 713. Surface disturbance may be similar to any surface disturbance processes described above. Furthermore, immobile blemish identification may also be similar to the processing and comparisons described above.

Thereafter, the method 700 may optionally continue imaging the surface of the product through iterations of blocks 707, 709, and 705 to identify other blemishes, or may submit the product being inspected for further processing at block 715 based on identification of immobile blemishes.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a computer readable medium for controlling manufacturing operations or as computer readable code on a computer readable medium for controlling a manufacturing line. The computer readable medium is any data storage device that can store data which can thereafter be read by a computer system. Examples of the computer readable medium include read-only memory, random-access memory, CD-ROMs, HDDs, DVDs, magnetic tape, and optical data storage devices. The computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A method for in-line cosmetic inspection of at least a portion of a surface of a product, comprising:
identifying if at least one blemish exists on the portion of the surface;
disturbing the portion of the surface based on the identifying; and
determining if the at least one blemish is immobile based on the disturbing.

2. The method of claim 1, wherein the identifying comprises:
imaging the portion of the surface to create a first image; and
processing the first image to identify the at least one blemish.

3. The method of claim 2, wherein the determining comprises:
imaging the portion of the surface to create a second image; and
comparing the first image to the second image to determine if the at least one blemish is immobile.

4. The method of claim 3, wherein the disturbing comprises:
controllably releasing a fluid flow over at least the portion of the surface.

5. The method of claim 4, wherein the fluid flow is a flow of compressed air.

6. The method of claim 3, wherein the disturbing comprises:
mechanically vibrating the surface of the product.

7. The method of claim 1, further comprising:
receiving the product from a manufacturing line; and
reinserting the product to the manufacturing line based on the determining.

8. A method for in-line cosmetic inspection of a product, comprising:
identifying blemishes on a surface of the product;
disturbing the surface of the product based on the identifying; and
determining if the identified blemishes are immobile based on the disturbing.

9. The method of claim 8, wherein the identifying blemishes comprises:
imaging the surface of the product to create at least one image; and
processing the at least one image to identify the blemishes.

10. The method of claim 9, wherein the determining comprises:
imaging the surface to create a second image; and
comparing the at least one image to the second image to determine if the identified blemishes are immobile.

11. The method of claim 10, wherein the disturbing comprises:
controllably releasing a fluid flow of compressed air over at least a portion of the surface of the product to dislodge mobile blemishes.

12. The method of claim 8, further comprising:
receiving the product from a manufacturing line; and
reinserting the product to the manufacturing line based on the determining.

13. A system for cosmetic inspection for products from a manufacturing line, comprising:
a cosmetic inspection station configured to receive a product from the manufacturing line;
a surface disturbance generator configured to disturb a surface of a product received at the cosmetic inspection station;
an image capture device configured to capture images of the surface of the product received at the cosmetic inspection station; and
a controller configured to identify immobile blemishes on the surface of products received at the cosmetic inspection station based on operation of the surface disturbance generator and the image capture device.

14. The system of claim 13, wherein the controller is configured to execute a method of in-line cosmetic inspection of products, the method comprising:
receiving a product from a manufacturing line at the cosmetic inspection station;
identifying if at least one blemish exists on a portion of a surface of the received product with the image capture device;
disturbing the portion of the surface with the surface disturbance generator based on the identifying;
determining if the at least one blemish is immobile with the image capture device based on the disturbing; and
reinserting the product to the manufacturing line based on the determining.

15. The system of claim 13, wherein the controller is configured to execute a method of in-line cosmetic inspection of products, the method comprising:
receiving a product from a manufacturing line at the cosmetic inspection station;
identifying blemishes on a surface of the received product with the image capture device;
disturbing the surface of the product with the surface disturbance generator based on the identifying;
determining if the identified blemishes are immobile with the image capture device based on the disturbing; and
reinserting the product to the manufacturing line based on the determining.

16. The system of claim 13, wherein the surface disturbance generator comprises:
a plurality of surface disturbance mechanisms configured to controllably release a fluid flow over a surface of a product received at the cosmetic inspection station.

17. The system of claim 16, wherein the plurality of surface disturbance mechanisms comprises:
a plurality of nozzles configured to release compressed air.

18. The system of claim 13, wherein the surface disturbance generator comprises:
a vibrating mechanical surface disturbance generator.

19. The system of claim 13, wherein the image capture device comprises:
at least one lens; and
at least one image sensor.

20. The system of claim 13, wherein the controller is further configured to direct a flow of products from the manufacturing line through the cosmetic inspection station and back onto the manufacturing line.
